(19) United States
(12) Patent Application Publication
(10) Pub. No.: US 2006/0153508 A1
(43) Pub. Date: Jul. 13, 2006

(54) System and method for deploying an optical fiber in a well

(75) Inventors: Thomas Bowker, Calgary AB (CA); Eric L Goldner, Valencia, CA (US); Michael Shaw, Calgary AB (CA)

Correspondence Address: FULWIDER PATTON, 6060 CENTER DRIVE, 10TH FLOOR, LOS ANGELES, CA, 90045, US

(73) Assignee: Sabeus Photonics, Inc., Corporation

(21) Appl. No.: 10/537,927

(22) PCT Filed: Jan. 15, 2004
(86) PCT No.: PCT/US04/00947

§ 371 Date: Jan. 25, 2006

Related U.S. Application Data
(60) Provisional application No. 60/440,255, filed on Jan. 15, 2003.

(51) Int. Cl. G02B 6/44

(52) U.S. Cl. 385/100

(57) ABSTRACT

A fiber optic sensor assembly capable of deployment down an instrumentation tube located in a well bore, including a flexible protective tube having a lumen encasing an optical fiber having a core portion and a cladding portion disposed within the flexible tube. The flexible protective tube protects the optical fiber from the oil, water or hydrogen gas within the well bore. A method of deploying the optical fiber down the well bore, is also provided. An optical fiber having a core and a cladding surrounded by the flexible protective tubing is deployed into the lumen of a tube disposed within the well bore by pumping a high pressure fluid into the lumen of the tube, thereby causing the deployment of the optical fiber down the well bore. The protective tubing is impermeable of hydrogen and other corrosive materials.

### CROSS-REFERENCE TO RELATED APPLICATION

This application claims the benefit of priority to U.S. Provisional Application No. 60/440,255, filed Jan. 15, 2003, the subject matter of which is incorporated herein in its entirety.

### BACKGROUND OF THE INVENTION

1. Field of the Invention

The invention relates to an improved method for deploying fiber optic sensors into hostile environments such as down well bores.

2. General Background and State of the Art

Fiber optic sensors are beginning to be used in oil and gas fields to sense parameters of interest to operators such as temperature and pressure down well bores. The primary advantages of fiber optic sensors include the complete elimination of electronics from the well bore as well as the sensors small size and weight. The optical fiber itself serves as both the sensor and the telemetry path. Since the optical fiber itself is hair-thin and therefore relatively delicate, special care must be taken to protect it as it is being placed in the well bore and during normal operation of the well. One such method that has been seeing widespread use is to install a small hollow metal tube, sometimes referred to as a capillary tube or instrumentation tube, having an outside diameter of approximately 114 inch down the well as it is being completed. Such tubes are also typically installed in well bores for other purposes, such as chemical injection.

Frequently, when the purpose of deployment is for testing, an electrical conductor is also installed to operate a testing device or apparatus. In many instances, the optical fiber cable is deployed in the capillary tube that has already been installed in the well. A fiber optic cable is basically comprised of a glass or plastic fiber core, one or more buffer layers, and a protective sheath. The optical fiber is typically a single optical fiber strand, coated with a thin layer of a protective material. The protective sheath is typically composed of a heat polymerized organic resin and may be impregnated with reinforcing fibers. A typical fiber optic is not sufficiently robust for installation in well bores where the operating temperatures may reach 250° C. In addition, the fiber optic cable frequently must be installed at lengths of up to 40,000 feet. State-of-the-art apparatus for installing such fiber optic cable typically include means for pulling the cable from a cable reel, propelling the cable by means of tractor gears, or a capstan, and in some cases, impelling the cable through the duct by means of fluid drag. All of the state-of-the-art methods for installing the cable place various stresses on the fiber optic core, causing degradation in the performance of the cable, and reducing the ability of the cable to resist conditions in which the cable may be installed.

Following completion of the well, an optical sensing fiber is installed inside the instrumentation or capillary tubing by pumping a fluid down the tubing and using the velocity of the fluid to drag the fiber down the tubing. One advantage of this approach is the ability to replace a failed optical fiber, i.e., by pumping it out and re-pumping in a new one without interrupting the normal operation of the well. Such an interruption of well operation is commonly called an intervention, and is typically expensive, therefore to be avoided if possible.

There are several disadvantages associated with the current method of fiber deployment. First, the fluids used to pump the fiber down the instrumentation or capillary tube may be harmful to the optical fiber and lead to failure of the optical fiber over time, especially at the elevated temperatures typically seen within a well bore. Although various fluids have been provided that minimize degradation of the optical fiber, it is believed that all of the presently available pumping fluids will degrade the fiber over time to the extent that the optical fiber is eventually rendered unusable and requires replacement. Although pumping the fiber out of the well, and deploying a new fiber is possible, as described above, the procedure is time consuming and expensive even though the well-continues to operate during the removal and re-deployment of the fiber.

Further, it is well known that any moisture (water) present in the instrumentation or capillary tube will also seriously attack the integrity of the optical fiber at elevated temperatures. In addition, hydrogen gas, normally found in many oil and gas wells, tends to seep into the instrumentation or capillary tubing over time. The hydrogen gas is absorbed by the optical fiber, causing the fiber to darken at the high temperatures typically found down a well bore, reducing the amount of light transmitted by the fiber, and degrading the performance of the fiber as a sensor.

The end result of the above described processes is that the optical fiber fails regularly when subjected to high temperatures within the well bore, sometimes in a matter of days, and has to be replaced. Although replacement of the fiber does not require an intervention, the fiber costs tens of thousands of dollars, and special equipment, personnel, and the like have to be brought to the well site, which may be located in an isolated area, to remove the damaged fiber and deploy a new fiber.

What has been needed, and heretofore unavailable, is an optical fiber that is protected or armored in such a manner so as to prevent the harsh environment within a well bore from degrading the optical fiber. For example, what has been needed is an optical fiber that is encased in a protective coating, or tubing, that is impervious to water vapor or gas transmission and thus does not appreciably add to the cost of the fiber, but which can be deployed using currently available equipment and technology. The present invention fills these and other needs.

### SUMMARY OF THE INVENTION

The present invention is embodied in an optical fiber assembly capable of deployment down an instrumentation tube located in a well bore, comprising, in its broadest aspect, a flexible protective barrier within which is disposed an optical fiber having a core and a cladding, the protective barrier being sufficiently flexible to allow storage of the fiber assembly in a spooled condition, and having an outer diameter sized to easily fit within an instrumentation or capillary tubing though which the fiber assembly is pumped down into a well bore. The protective barrier encases the fiber assembly and prevents the permeation of water, oil, gas or other potentially corrosive substances into the fiber assembly.

In one embodiment, the protective barrier is impermeable to fluids, water vapor and gases, such as hydrogen gas. A thin tubing into which the fiber optic core and cladding are threaded protects the optic fiber from the harsh environments of the well bore and provides a flexible tubing assembly for storage spooling and unspooling during fiber optic cable deployment. The thin tubing may be formed from nickel or stainless steels, or other materials that prevent the transmission of deteriorating substances into the fiber. The protective tubing may include a hydrogen scavenging material coating on the outer side of the tubing. As fiber optic cable assemblies are subjected to elevated temperature and extraneous harsh conditions in the well bore, the hydrogen scavenging material prevents hydrogen vapors from permeating the protective barrier. The hydrogen scavenging material may be applied on the inner side of the metal tubing for removal of hydrogen that may permeate the protective barrier.

In another embodiment, the protective barrier is a coating which is impermeable to water vapor and fluids, and which is reactive with hydrogen gas to form molecules that cannot permeate into the fiber. Suitable coating materials may include carbon or other material known to getter hydrogen. Alternatively, the protective coating may consist of a plating material applied to the fiber optic cable cladding material, encasing the core and cladding therein. A non corrosive material is highly preferred to withstand the harsh environment of within the well bore.

In still another embodiment, the protective barrier is a metal tube through which an optical fiber is disposed. The metal tube has a wall thickness that provides flexibility to the metal tube, allowing the tube and fiber to be spooled for storage, and unspooled for deployment. The metal tube is designed for deployment within the capillary tubing. Preferably, a hermetically sealed tube provides enhanced protection to the optical fiber sensor and to the fiber optic cable assembly. In another embodiment, the metal tube is coated with a coating that forms traps for hydrogen molecules is reactive with hydrogen gas to form molecules that cannot permeate the tube. Such coatings may be made of palladium or copper oxide.

The present invention also includes a method for deploying an armored optical fiber down into a well bore. In one embodiment, the method comprises disposing an optical fiber having a core and a cladding surrounded by a flexible protective means into the lumen of a tube disposed within the well bore and pumping a fluid under high pressure into the lumen of the tube disposed within the well bore, the pumped fluid acting on the optical fiber to drag the optical fiber down the well bore. In another embodiment, the method also includes mounting a drag enhancer, such as a pig, as that term is understood in the art of oil field exploration, maintenance and operation, on the end of the fiber tubing to enhance the drag of pumped fluid on the fiber tubing so as to improve the rate of deployment of the fiber tubing down the well bore.

Other features and advantages of the present invention will become apparent from the following detailed description, taken in conjunction with the accompanying drawings, which illustrate, by way of example, the principles of the present invention.

### BRIEF DESCRIPTION OF THE DRAWINGS

FIG. 1 is cross-sectional view of an oil and/or gas well, illustrating the location of various structural components thereof, including the location of an instrumentation tubing;

FIG. 2 is graphical representation, partially in cross-section, illustrating an embodiment of the present invention including an optical fiber encased within a tubing that is deployed into a well by pumping the tubing down an instrumentation tube;

FIG. 3 is a cross-sectional view of a fiber tubing assembly incorporating aspects of the present invention;

FIG. 4 is a cross-sectional view of a fiber tubing assembly of FIG. 1, further depicting a coating material providing the protection barrier for the fiber optic cable;

FIG. 5 is a cross-sectional view of a fiber tubing assembly of FIG. 1, depicting a hydrogen scavenging material applied to the inside of the fiber tubing; and

FIG. 6 is a cross-sectional view of a fiber tubing assembly of FIG. 1, depicting a hydrogen scavenging material applied to the outside of the fiber tubing.

### DETAILED DESCRIPTION OF THE PREFERRED EMBODIMENTS

The present invention is well suited for use within a high temperature, hazardous environment. The device of the invention is suitable for use in a caustic, high temperature and pressure environment, such as the environment found downhole in an oil or gas well. Well bores range in depth from several hundred to several thousand feet. Consequently, hydrostatic pressure within a deep bore, in addition to high well head pressures caused by gas production, can be quite large and can reach and often exceed 70 MPa (approximately 10,000 pounds per square inch). Ambient well temperatures on the order of 200° C. (392° F.) are not uncommon. In addition, oil wells typically contain highly corrosive hydrogen sulfide and carbon dioxide gases. These harsh environmental conditions dictate that fiber optic cable and equipment must be enclosed within protective tubing or barriers.

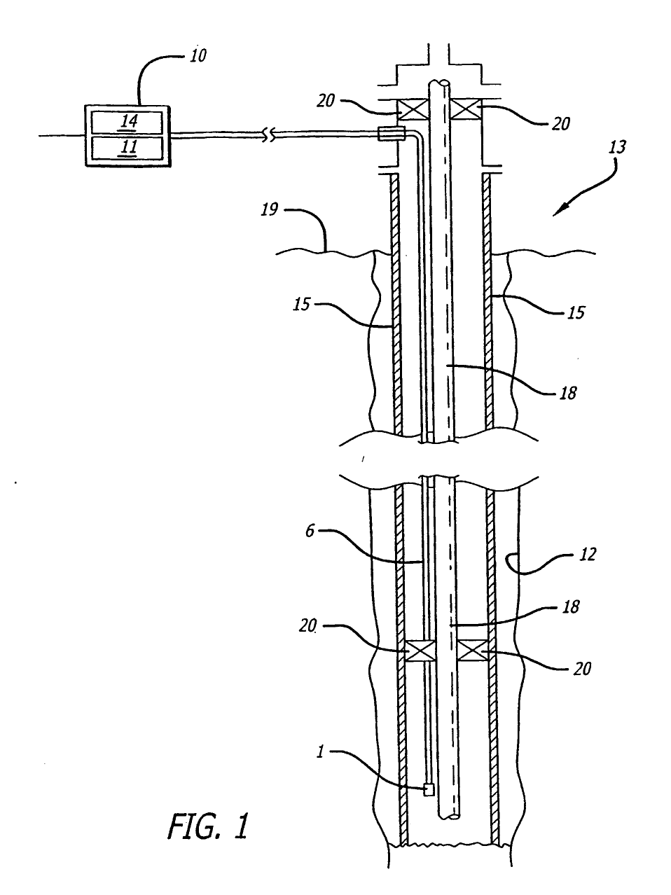

Referring now to FIG. 1, a typical well bore having an instrumentation tubing placed therein is depicted. A pressure sensor may be located at the distal end 1 of instrumentation or capillary tubing 6, which is positioned within a well bore 12 of an oil and/or gas well 13. The pressure sensing device may be interconnected via appropriate optical fibers, couplers, and the like, to optical signal processing equipment 10, which is located above the surface of the well bore 12. Well bore 12 may also include casing strings 15 for reinforcing the well bore 12, production tubing 18 for pumping or releasing oil and/or gas from the well 13 and production packers 20.

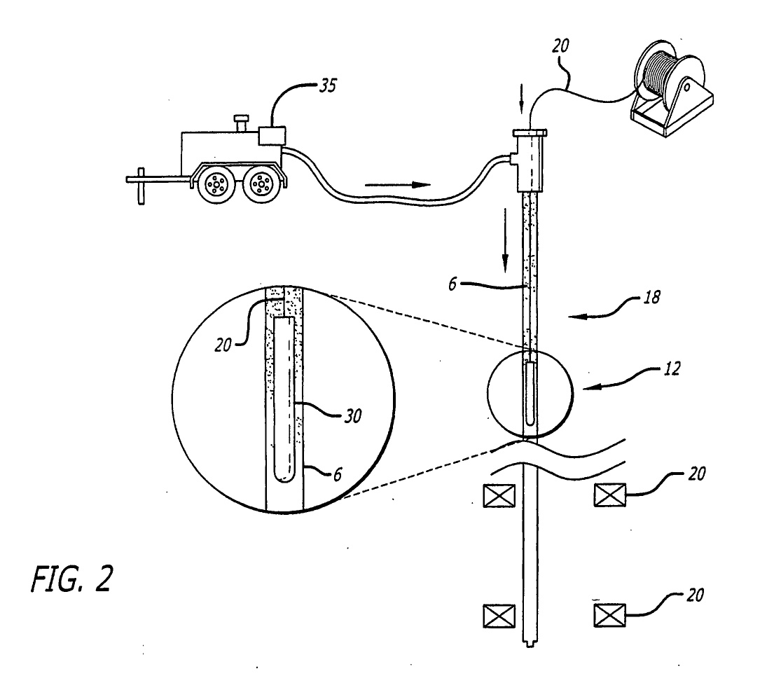

FIG. 2 depicts the method typically used to deploy an optical fiber down a well bore. An optical fiber is inserted through a fitting designed to allow the instrumentation tubing 6 to be pressurized. A high pressure water pump 35 is also operably connected to the instrumentation tubing 6. High pressure water or other appropriate fluid such as one of a number of common silicone oils is pumped down the instrumentation tubing 6. As the high pressure fluid flows down the instrumentation tubing 6, the optical fiber is dragged along with the high pressure water towards the distal, or down hole, end of the instrumentation tubing 6. Pressurized water dragging or installing fiber optic cable presents an opportunity for moisture to enter the fiber optic cable assembly and degrade the optical fibers therein.

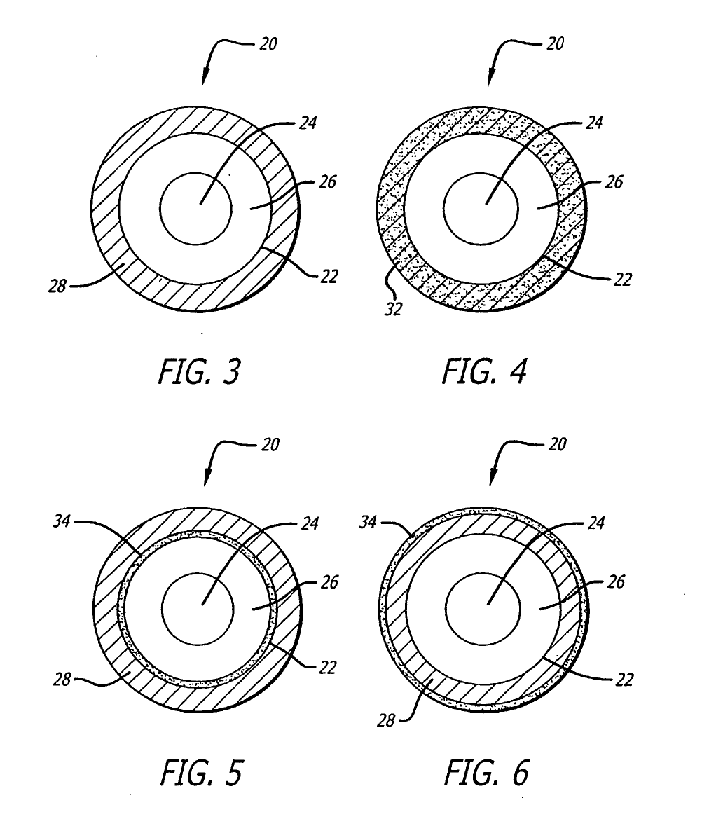

As it is well established in the art, a common optical fiber consist of three parts: the core, the cladding, and the coating or buffer. FIG. 3 illustrates one embodiment of an optical fiber tubing 20 incorporating aspects of the present invention. Optical fiber tubing 20 includes an optical fiber 22 having a core 24 and cladding 26 encased in a thin tube 28 or coating 32 which provides protection to the optical fiber when it is deployed within the well bore 12 (FIGS. 1-2). The core is the light-guiding central portion of the optical fiber, composed of a material transparent to the wavelength of light being guided. The cladding is the material that surrounds the core of an optical fiber, having a lower index of refraction compared to that of the core. In prior art, the material surrounding the cladding is typically a soft plastic material that protects the fiber from damage. The present invention embodies a robust material surrounding the cladding, and providing a barrier protecting the fiber optic cable from the harsh environment and corrosive substances of the well bore.

In one embodiment of the present invention, optical fiber 22 is encased within a thin tubing 28 that is flexible enough so that the optical tubing assembly 20 may be wound and stored on a spool. For example, an optical fiber may be threaded into a length of tubing having a diameter in the range of 0.046 inch and a wall thickness of between 0.005 inch and 0.006 inch. Since the final assembly of the fiber tubing 20 has a diameter of approximately 0.046 inch, it will easily fit within instrumentation tubing 6, which typically has an inner diameter of 0.190 inch. Tubing 28 may be made from stainless or nickel steels, or other materials that prevent the transmission of water vapor or gas from the well into the fiber, and which are flexible enough in the appropriate cross sections to allow the final fiber tubing assembly to be spooled and deployed down instrumentation tubing 6 using currently available equipment. One disadvantage of currently available fiber optic sensor assemblies is that their increased diameters, due to the inclusion of several layers of tubing and filling, reduces flexibility during storage spooling, and unspooling during deployment; the present invention overcomes this disadvantage.

Preferably, the thin tubing 28 that encases the optical fiber 22 is made of a non-corrosive material. The harsh environment of the well bore, including high temperature oil and/or gas, may accelerate the onset of corrosive effects on the tubing material, thus making the optical fiber susceptible to degradation. Alternative tubing materials may include corrosion resistant metal alloys such as, for example, high nickel content iron compounds and like materials that provide protection from corrosion, especially in harsh environments.

In another embodiment of the present invention, as illustrated in FIG. 4, an optical fiber 22 is coated with a material 32 that provides protection to the optical fiber, prevents the transmission of water vapor or gas through the coating, and is flexible enough so that the final assembly can be spooled and deployed down a well bore using currently available equipment. The material selected should provide the desired fiber optic protection while still providing fiber optic cable flexibility during unspooling down the well bore for deployment. Suitable coating materials may include carbon or other hydrogen getter material. Alternatively, the protective coating 32 may consist of a plating material such as, for example, palladium or oxidized copper, applied to the fiber optic cable cladding material, encasing the core 24 and cladding 26 therein.

In yet another embodiment of the present invention, a small pig 30 or drag enhancer is attached to the distal end of the optical fiber tubing 20. The pig 30 has a larger diameter than the fiber tubing 20, but has a smaller diameter than the inner diameter of the instrumentation tubing 6. Because the outer diameter of the pig 30 is larger than the outer diameter of the fiber tubing 20, the pig offers more resistance to the flow of the high pressure water down the bore hole, thus enhancing the deployment of the fiber tubing 20 down the well hole. For example, in one embodiment, the pig may have and outer diameter of approximately 0.160 inch, and may be, for example, approximately two inches long. In one experiment conducted by the inventors, water was pumped down an instrumentation tube of a well at 3000 psig to pump a fiber tube assembled in accordance with the present invention down the instrumentation tubing. The deployment operation took approximately 3.5 minutes to pump the fiber tube down the entire length of the instrumentation tubing.

In another experiment, the same length of instrumentation tubing having a smaller diameter (0.46 inches O.D.) was placed down a well. A small pig (0.160 inches O.D., approx. 2.0 inches long) was attached to the end of the fiber tube. Fluid (water) at 3000 psig was used to pump the fiber tube down the instrumentation tubing. In this experiment, deployment took approximately 3.5 minutes to pump the fiber tube down the entire length of the instrumentation tubing.

The present invention retains the ability to install/replace the optical fiber sensor within a previously installed hollow metal instrumentation tube, while protecting the fiber from being degraded from injection fluids, moisture, and hydrogen present within the well bore. In another embodiment of the present invention, the optical sensor fiber 22 is enclosed inside a small diameter metal tube 28 that can be hermetically sealed. This fiber tube is similar to the tubing used to house fibers in long haul undersea fiber optic telecommunications cables. The fiber tubing has a substantially smaller outer diameter than the inner diameter of the instrumentation tubing, such that it easily fits inside the instrumentation tubing. Thus, rather than pumping bare optical fiber down the instrumentation tubing, optical fiber enclosed in the sealed fiber tubing is pumped down the instrumentation tubing.

The tubing that encases the optical fiber protects the fiber during deployment and during actual operation, and is significantly more robust than bare fiber, having a breaking strength more than 10 times that of a typical optical fiber. Moreover, the fiber inside the tubing is never exposed to the injection fluids used to pump it down the instrumentation tubing, minimizing exposure to injection fluids as a source of fiber degradation. Further, since the tubing encasing the fiber can be hermetically sealed, moisture can be kept away from the fiber, thus eliminating another major source of optical fiber failure. Alternatively, the fiber tubing can be filled with an inert gas such as nitrogen.

In yet another embodiment of the present invention, a hydrogen scavenging material 34, commonly used in telecommunications cables, may be placed inside the sealed fiber tubing along with the optical fiber to scavenge hydrogen that permeates the metal walls of the fiber tubing before it can be absorbed by the optical fiber and damage the fiber (FIG. 5). High temperature variants of hydrogen scavenging materials can be used and are particularly advantageous in the type of high temperature environment that typically exists deep inside a well bore.

In another embodiment, as illustrated in FIG. 6, a coating material can be applied to the outside of the fiber tube. In this embodiment, the coating reacts with hydrogen in the well bore to form larger molecules that cannot pass through steel of the fiber tubing. In yet another embodiment, a hydrogen scavenging material may be pumped down the instrumentation tubing in which the fiber tubing is deployed. Commonly used hydrogen scavenging materials in telecommunications cables, may include palladium or tantalum, applied as an additive filler material or a coating on the fiber optic cable tubing.

The present invention also includes a method for disposing an optical fiber having a core and a cladding surrounded by a flexible protective means into the lumen of an instrumentation tube within a well bore. In this method, fluid is pumped under high pressure into the lumen of the tube disposed within the well bore, the pumped fluid acting on the optical fiber to drag the optical fiber down the well bore. The optical fiber is encased in a protective means in accordance with the various embodiments of the invention described above. Such protective means may include encasing the fiber optic sensor cable in a thin flexible tubing, a protective coating or a metal protective tubing that is hermetically sealed. The flexible tubing may also include an additional protective coating or scavenging layer for providing enhanced protection to the optical fiber from potential contaminants found within the bore hole.

In another embodiment, the method also includes mounting a drag enhancer, such as a pig, as that term is understood in the art of oil field exploration, maintenance and operation, on the end of the fiber tubing to enhance the drag of pumped fluid on the fiber tubing so as to improve the rate of deployment of the fiber tubing down the well bore.

While several particular forms of the invention have been illustrated and described, it will be apparent that various modifications can be made without departing from the spirit and scope of the invention. Accordingly, it is not intended that the scope of the claims be limited except as according to the appended claims.

What is claimed is:

1. An optical fiber assembly capable of deployment down an instrumentation tube located in a well bore, comprising:
a flexible tube having a lumen surrounded by a wall, the lumen having an inner diameter, the flexible tube also having an outer diameter smaller than an inner diameter of the instrumentation tube; and
an optical fiber having a core portion and a cladding portion disposed within the flexible tube, the optical fiber having an outer diameter smaller than an inner diameter of the lumen of the flexible tube.

2. The assembly of claim 1, wherein the flexible tube is hermetically sealed.

3. The assembly of claim 1, wherein the flexible tube is filled with a hydrogen scavenging material.

4. The assembly of claim 1, further comprising:
a coating applied to an outer surface of the flexible tube for preventing permeation of fluid or gas through the wall of the flexible tube.

5. The assembly of claim 4, wherein the coating is a material that reacts with hydrogen.

6. The assembly of claim 2, wherein the inner wall of flex tube is coated with hydrogen scavenging material.

7. An optical fiber suitable for deployment in a harsh environment, comprising:
an optical fiber having core portion and a cladding portion; and
a flexible barrier material disposed about an outer diameter of the optical fiber for protecting the optical fiber from the harsh environment.

8. The optical fiber of claim 7, wherein the flexible barrier is a thin tubing.

9. The optical fiber assembly of claim 7, wherein the flexible barrier encases the optical fiber, core portion and the cladding portion.

10. The optical fiber assembly of claim 7, wherein the flexible barrier is made of a material that prevents the transmission of water vapor or gas from the well in the fiber.

11. The optical fiber assembly of claim 10, wherein the flexible barrier is made of stainless steel.

12. The optical fiber assembly of claim 10, wherein the flexible barrier is made of nickel steel.

13. The optical fiber assembly of claim 7, wherein the flexible barrier member further includes a drag enhancer attached to the flexible barrier, wherein the drag enhancer provides resistance to the flow of the optical fiber assembly during deployment.

14. The optical fiber assembly of claim 7, wherein the flexible barrier is hermetically sealed.

15. The optical fiber assembly of claim 7, wherein the flexible barrier further includes a hydrogen scavenging material.

16. The optical fiber assembly of claim 8, wherein the flexible barrier includes coating applied to an outer surface of the flexible barrier for preventing permeation of fluid or gas through the wall of the flexible barrier.

17. The optical fiber assembly of claim 16, wherein the coating is a material that reacts with hydrogen to form a molecule that cannot permeate the wall of the flexible barrier tube.

18. A method of deploying an optical fiber down a well bore, comprising:
disposing an optical fiber having a core and a cladding surrounded by a flexible protective means into the lumen of a tube disposed within the well bore;
pumping a fluid under high pressure into the lumen of the tube disposed within the well bore, the pumped fluid acting on the optical fiber to drag the optical fiber down the well bore.

19. The method of claim 18, wherein the optical fiber includes a drag enhancer disposed at a distal end of the optical fiber.

20. The method of claim 18, wherein the flexible protective means is a hermetically sealed tube.

21. An optical fiber assembly for deployment down a capillary tube located in a well bore, comprising:
an optical fiber having a core portion and a cladding portion;
a flexible protective tube having an outside surface and an inside surface, the inside surface encasing the optical fiber, the flexible tube being hermetically sealed; and
a hydrogen scavenging material applied to the inside surface of the flexible tube for preventing permeation of fluid or gas through the flexible tube.

22. The optical fiber assembly of claim 21, wherein the hydrogen scavenging material is applied on the outside surface of the flexible tube.

23. The optical fiber assembly of claim 21, wherein the flexible tubing is formed by applying a coating to an outer surface of the optical fiber.

24. The optical fiber assembly of claim 23, wherein the coating material reacts with hydrogen.

25. The optical fiber assembly of claim 21, wherein the optical fiber has a distal end having a drag enhancer mounted thereto.
